(19) United States
(12) Patent Application Publication
(10) Pub. No.: US 2021/0070641 A1
(43) Pub. Date: Mar. 11, 2021

(54) MODULAR BIO BED AND VENTILATED SYSTEM FOR WASTE WATER TREATMENT

(71) Applicant: DRAIN FIELDS PATENTS AB, kARLSKRONA (SE)

(72) Inventor: Bert GUSTAFSSON, FÅGELMARA (SE)

(21) Appl. No.: 16/642,322

(22) PCT Filed: Sep. 17, 2018
(86) PCT No.: PCT/EP2018/075054

§ 371 Date: Feb. 26, 2020

(30) Foreign Application Priority Data
Sep. 18, 2017 (SE) 1751144-5
Dec. 12, 2017 (SE) 1751532-1

(51) Int. Cl. C02F 3/10; C02F 3/04; C02F 1/00

(52) U.S. Cl. CPC C02F 3/101; C02F 3/043; C02F 3/103; C02F 2301/028; C02F 2201/007; C02F 2203/006; C02F 1/006

(57) ABSTRACT

In a method for treatment of waste water, a module (5) is used which includes a number of carrier elements (7) arranged in a sandwich structure and configured to be perfused a flow of waste water. The module (5) further has a number of partitions (8) arranged between carrier elements (7) and configured to direct the flow of waste water through the module (5). The module (5) may also be used in a system together with an air supplying device (20) and a waste water vessel. The air is supplied to the module (5) by the air supplying device (20).

### TECHNICAL FIELD

The present invention relates to a module and a method for treatment of waste water, as well as a carrier element for growing bacteria, a use of the carrier element and a waste water treatment system.

### BACKGROUND

Purifying sewage water from hostile compounds, such as organic nutrients is of great importance in order to avoid contamination of the environment. Unpurified sewage or waste water also imposes a large infection risk among humans and animals.

One way of purifying sewage water biologically is by using so-called bio modules, which for instance can be used to treat the waste water before infiltration or can be incorporated into a bio bed. A bio module provides a surface area for the growth of a bio film hosting bacteria suitable for the degradation of contaminating particles. Water flows through the bio module and the bacteria in the bio film cleanses the water in a biological process. Hence, a large amount of bio film provides efficient water purification. To ensure a substantial bio film, it is advantageous to provide a certain amount of oxygen to the bio film. A lack of oxygen results in a “dead” bio film which is unable to purify the water properly. Dead bio material also causes clogging of the bio module which can make it completely disabled. Furthermore, many bio modules are demandingly large in size. To attain a large surface area for the bio film and yet sustain a good enough oxygen flow is a difficult task for the industries in this field.

There are several bio modules available on the market. One kind of bio bed called “WmFilter” is marketed by the Swedish company Wostman Ecology AB and is presented in their Swedish-language brochure entitled “Kompaktbädden for BDT-avlopp” from 2016. This bio bed includes hollow, cylindrical bio blocks with a geo textile creased between them to achieve the mentioned surface for growth of bio film. Another type of product is marketed by the Swedish company FANN VA-teknik AB, namely a module called “IN-DRÄN” which is presented in a Swedish-language brochure entitled “Ekologisk avloppsrensning med IN-DRÄN teknologi” from 2016. This module uses a thermoplastic material as a spacer between a creased textile material. The textile provides a growth surface for the bio film and every other fold is filled with water and the remaining folds hold oxygen.

The known bio modules discussed above, as well as many others, still suffer from certain drawbacks. Neither of these structures have managed to circumvent the issues with clogging due to oxygen deficiency.

The Swedish applicant company BAGA Water Technology AB is marketing bio modules which have solved many of the existing problems. Some of these bio modules referred to as “BAGA Easy” are shown in BAGA's English-language brochure entitled “Sewage plants for single households up to 1000 people (and more)” from 2014. Since the technology behind bio modules depends on a balance between a large surface area and oxygen supply, there is still a need for further developments within the field.

Examples of prior-art water treatment systems are disclosed in US2004/0074839A1 and in the utility model publication CN200984481U. However, in these known systems the oxygen supply is poor yielding an unsatisfying cleansing of the waste water. Further background art is reflected in US2007/0181474A1.

As mentioned above, for the biological treatment to be efficient in the bio module, oxygen needs to be supplied to the bacteria contained therein, which contributes to the degradation of contaminating particles. Air supply can be attained through an aeration pipe or by actively supplying air by means of an air supplying device, such as a compressor or an air pump. If the bio module is a subsurface unit, the air inlet and air outlet of the module are accompanied by aeration pipes protruding through the soil and beyond the ground surface. These aeration pipes are often damaged due to their vertical extension above the ground surface, causing malfunction of the waste water treatment system. It also happens that users cut off the vertically protruding aeration pipes, which disturbs the aeration of the bio module. The aeration pipes may also spread undesired foul smell in to the environment of residential buildings.

An example of a prior-art system is disclosed in WO-A-00/55098 where the air outlet channel from the waste water treatment system is placed on the roof of a building. However, users might find also this an unattractive visual feature of a house and it will not solve the issue with possible scent. The system known from WO-A-00/55098 suffers from at least some of the drawbacks discussed above.

There are known waste water treatment systems where a septic tank is connected to a leach field instead of a bio module. Reference is made to “The Presby Wastewater Treatment System” issued by Presby Environmental, Inc. from 2014. Another example is disclosed in U.S. Pat. No. 2,432,887A. In a leach field, the waste water flows directly from a septic tank into the soil of the leach field. This means that the leach fields have to be large enough not to saturate the soil with waste water, rendering a need for a lot of space. Further, the waste water flowing into the leach fields have not been cleansed biologically as when using a bio module. In addition, the systems known from “The Presby Wastewater Treatment System” and U.S. Pat. No. 2,432,887A both suffer from at least some of the drawbacks discussed above.

From the above it is understood that there is room for improvements in this technical field.

### SUMMARY

An object of the present invention is to provide a concept which is improved over prior art and which solves or at least mitigates the problems discussed above. This object is achieved by the technique set forth in the appended independent claims, preferred embodiments being defined in the related dependent claims.

The present disclosure is—inter alia—based on the idea that an increased surface area in a bio module is achieved if twisted and irregular filaments are provided in a carrier element of the bio module. The surface area where bacteria may grow bio film which cleanses the waste water biologically is thus increased. If the carrier elements are arranged in a sandwich-like structure, and combined with partitions, the flow of the waste water through the bio module may be directed. The control of the flow of the waste water will cause the waste water to be maintained in the bio module for a substantial time so that the a satisfactory biological cleansing is achieved. The present disclosure is also based on the idea that an addition of oxygen to the bio module will increase the performance of the bio module. Pressurized air which is introduced into the bio module may be reused in a waste water treatment system, if an air pipe is connected between the air outlet of the bio module and a septic vessel in the waste water treatment system. This leads to an improved processing already in the septic vessel.

In a first aspect, there is provided a module for treatment of waste water. The module comprises a number of carrier elements arranged in a sandwich structure. The carrier elements are configured to be perfused by a flow of waste water. The module further comprises a number of partitions arranged between the carrier elements and configured to direct a flow of waste water through the module. This is an advantageous waste water treatment module in that the sandwich structure separated by partitions causes the water to travel a longer distance through the module compared to other types of water treatment devices. The purification is enhanced since the waste water travels within the module for a time period which promotes the purification process. Furthermore, the inventive module represents a very compact structure with a reduced footprint compared to prior-art modules. The compactness makes the module cheaper to produce, and also cheaper and easier to install since less soil masses must be moved in order to bury the module.

In an embodiment, the carrier elements and the partitions are configured to be covered by microbial growth. The microbial growth comprises microbes and forms a so-called bio skin on the carrier elements and partitions. The microbes provide for an effective purification of the waste water passing through the water treatment module.

In one embodiment, the partitions are arranged to direct the flow of water in a meandering manner through the module. This causes the water to travel a long distance through the module, which means that it is more effectively purified.

Preferably, each carrier element comprises a plate of irregularly twisted filaments. This provides for a large surface area for the microbial growth to attach to, which results in a large amount of bio skin in each carrier element. Thus, a large surface area is achieved without the module being enlarged in size.

The partitions may comprise sheets of geo textile. This material is advantageous since it is easy and cheap to produce and easy to handle. It may for example comprise polyethylene. The partitions may alternatively comprise open pore foam plastics or other suitable permeable material. Further, since the partitions are preferably not made from organic material, they do not decompose in the water purification module.

The partitions are in one embodiment semi-permeable to water. Thus, some of the water which has entered the module will pass through the partitions. Since the microbial growth requires moist in order to survive, it is advantageous to use a semi-permeable partition, since the water passing through the partition causes the underside of the partition to become wet, such that the bio skin can grow there as well.

In one embodiment, the module further comprises a distribution pipe for delivering the waste water to the module. This is a preferred way of effectively direct water into the module.

The module preferably further comprises an air inlet channel and an air outlet channel for supplying oxygen to microbes. It is advantageous to have air channels such that the air circulation within the module is improved, compared to a module without such channels. Since the microbes need oxygen to grow, this is an advantageous arrangement.

In a second aspect, a method for treatment of waste water is provided. The method comprises the steps of providing a module, and supplying waste water to the module, wherein the water travels through the module. This method is advantageous in that it provides for effective treatment of the water passing through the module.

In one embodiment, the method further comprises the step of providing a suitable environment for microbial growth in the module, preferably by supplying oxygen and moist to the module. The microbes growing inside the module are advantageous for the treatment of the water, since they remove impurities from the water.

The water preferably passes partly through the partitions and partly travels along the carrier elements of the module such that the water passes the microbes purifying the water. This meandering and sub-divided flow path is advantageous in that the microbial growth on all sides of the carrier elements as well as on the partitions is promoted and benefiting from the moist and nutrition being brought to them by the water. By having all inner surfaces of the module hospitable for the microbes, the treatment becomes advantageously effective.

The method may further comprise the step of actively supplying air to the module by means of an air supplying device. This is advantageous in larger assemblies which comprise a couple or several modules connected to each other, when natural draft does not provide sufficient oxygenation to the microbes.

In one embodiment, the method comprises the step of leading the air supplied by the air supplying device through an air conduit, such that the air is diverted from the module into the waste water vessel. This embodiment is advantageous in that it provides for an efficient way to reuse oxygen in a waste water purification system. Also, the reuse of the oxygen supplied to the module allow for oxygenation of the waste water vessel without the need for an additional air supplying device. This saves space, electricity and the oxygenation of the waste water vessel improves the environment in the waste water vessel.

In another embodiment, air is supplied to generate an overpressure in the vessel, such that ventilation of the vessel is eased. By supplying pressurized air into the waste water vessel, the air pressure in the vessel increases and an overpressure is thus created therein. The overpressure is advantageous since the air flow out of a ventilation outlet of a household or another facility is enhanced, and an increased ventilation efficiency will decrease the risk of foul smell.

In a third aspect, a carrier element to be included in a waste water treatment module is provided. The carrier element comprises irregularly twisted filaments. This carrier element is advantageous since it provides a large surface area suitable for microbial growth to attach against.

In a fourth aspect, there is provided a use of a carrier element in a waste water treatment module. The carrier element is beneficial for use in a water treatment module since it is suitable for decomposing microbes to grow on.

In a fifth aspect, there is provided a waste water treatment system, which comprises a waste water vessel and at least one water purification module.

In a sixth aspect, there is provided a ventilated system for waste water treatment comprising a waste water vessel, a waste water treatment module, an air supplying device connected to an air inlet channel of the module, and an air conduit configured to lead air from an air outlet channel of the module to an air inlet of the vessel. This is advantageous since formerly used ventilation pipes protruding beyond a subsurface bio module above the ground surface, or other water treatment facilities arranged subsoil, are not needed and air is lead back into the water treatment vessel. Since the former protruding air pipes are removed, the risk of damaging these air pipes and thus damaging the effect of the purification process of the waste water is eliminated or at least mitigated. Further, the reuse of the supplied air improves the environment of the waste water vessel. It is also environmentally friendly to reuse the air instead of supplying the waste water vessel with air from another air supplying device. The reusage of oxygen in this way saves space and energy.

Additional air supply to the module in the purification system increases the efficiency in the biological purification process. The additional oxygen also aids in preventing possible malfunction of the module since a lack of oxygen results in dead bio material which can cause clogging which eventually disables the module. The air supplying device ensures sufficient supply of oxygen to the water treatment system.

In one embodiment, the waste water vessel is arranged at least partly below a ground level. This is beneficial because the vessel does not take up space above ground level. A vessel above ground surface might also be an unattractive object to look at.

Preferably, the waste water vessel is a septic tank or a sludge separator. This is favorable since a septic tank or sludge separator has the capability of sediment particle impurities from the waste water before the waste water flows into the module. This further decreases the risk of clogging in the module and facilitates the biological cleaning process in the module.

In a further embodiment, the module is configured to receive air through an air inlet channel and to lead the air out of the module through an air outlet channel. It is advantageous to have air channels like these in a water treatment module since it enhances the air circulation within the module. The circulation aids the microbes in their purification process of the water.

In another embodiment, a first end portion of the air conduit is connected to the air outlet channel of the module, and a second end portion of said air conduit is connected to said waste water vessel. This is advantageous because a closed system for reusing the inlet air within the system is created.

In one embodiment, the air inlet is located above a water level of the vessel. This is favourable since the risk of having waste water leaking out of the air inlet becomes mitigated. Another advantage is that a low air pressure is needed to press the air into the vessel.

In yet another embodiment, the vessel further comprises an air outlet configured to lead air to a ventilation valve. This is advantageous since it can prevent foul smell.

In another embodiment, the module is arranged in a bio bed. An advantage with this is that the purified waste water can leach into the soil beneath the module in a controlled manner. Since the waste water has been cleansed biologically in the module, the water leaching into the soil is more pure than if waste water is allowed to perfuse into a leach field directly from a waste water vessel, such as a septic tank.

In yet another embodiment, the air supplying device is one of a compressor, a membrane pump or an air pump. This is beneficial because an air supply device such as these can provide different air pressures and can be regulated depending on what type of module that is used.

In a seventh aspect, there is provided a kit for providing ventilation to a waste water treatment system, including a waste water treatment module and a waste water vessel. The kit comprises at least one air supplying device and an air conduit configured to feed air from the waste water treatment module to the waste water vessel. This is favourable since the kit can be provided to water treatment systems, preferably water treatment systems comprising a bio module or another type of module for treating waste water, which have already been installed and are in use. The systems can be modified with the kit so that air pipes protruding through the ground can be removed.

In an eighth aspect, there is provided a use of an air conduit in a waste water treatment system for connecting a waste water treatment module to a waste water vessel included in the system, such that air is reused.

### BRIEF DESCRIPTION OF THE D WINGS

Embodiments of the invention will be described in the following; references being made to the appended diagrammatic drawings which illustrate non-limiting examples of how the inventive concept can be reduced into practice.

FIG. 1 is a perspective view of a waste water purification system;

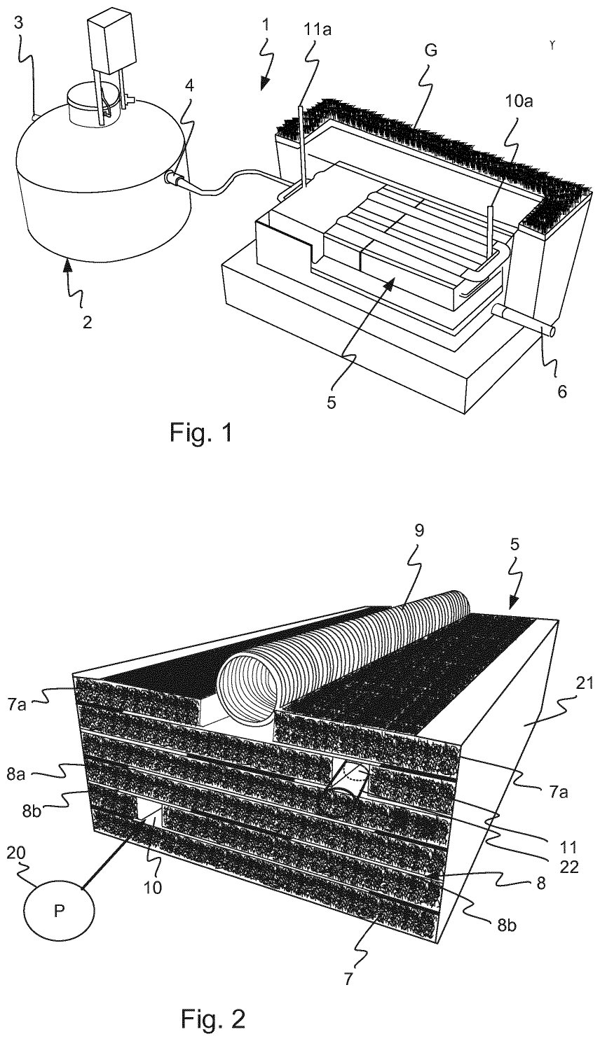

FIG. 2 is a perspective view of a bio module in accordance with an embodiment;

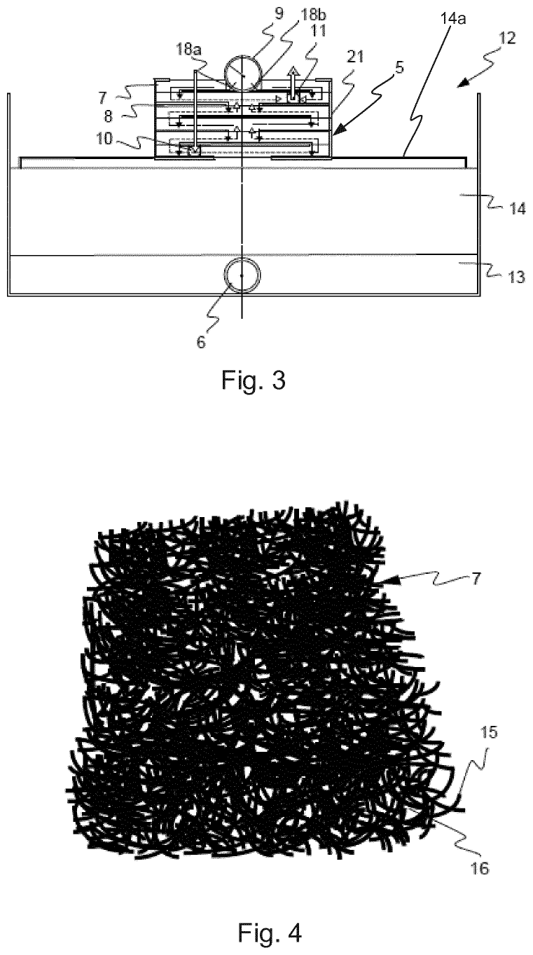

FIG. 3 is a cross section illustrating the bio module in FIG. 2 in a bio bed assembly;

FIG. 4 is a perspective view of a portion of a carrier element;

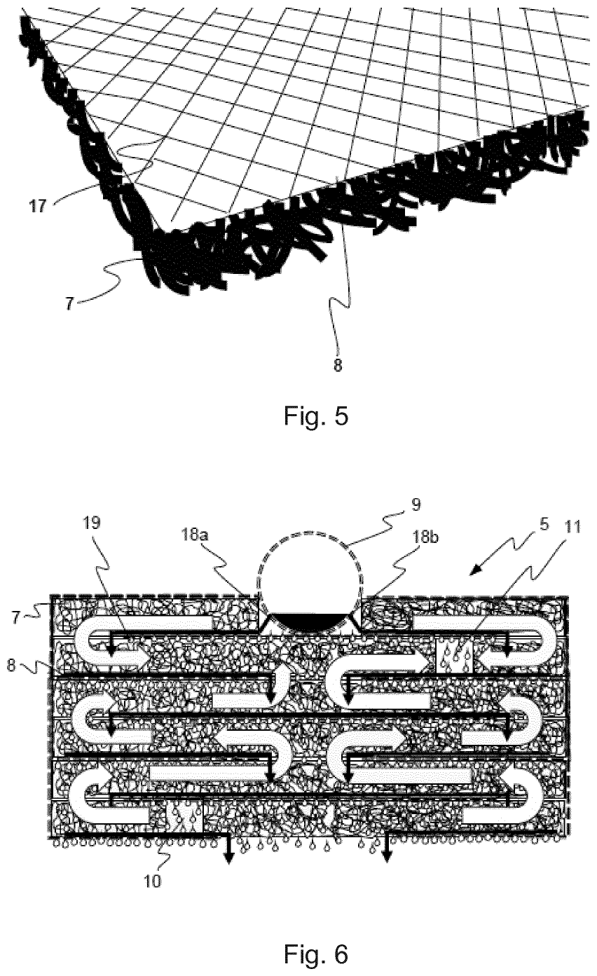

FIG. 5 is a perspective, partial view of a carrier element with a geo textile and a net according to an embodiment;

FIG. 6 is a cross section of the module shown in FIG. 2;

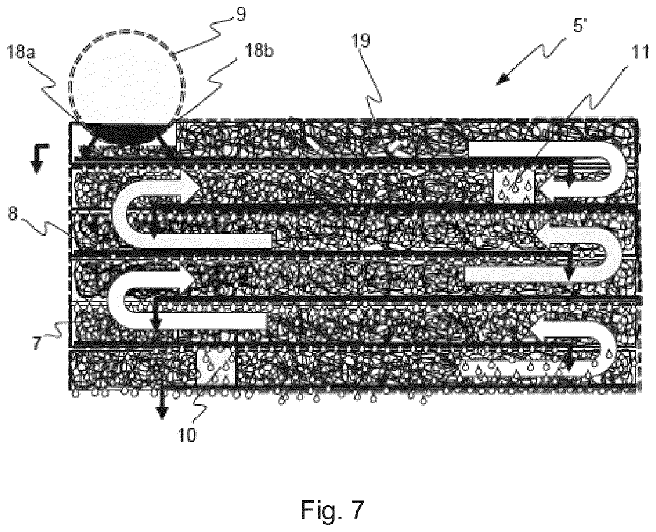

FIG. 7 is a cross section similar to FIG. 6 showing a bio module in accordance with a further embodiment;

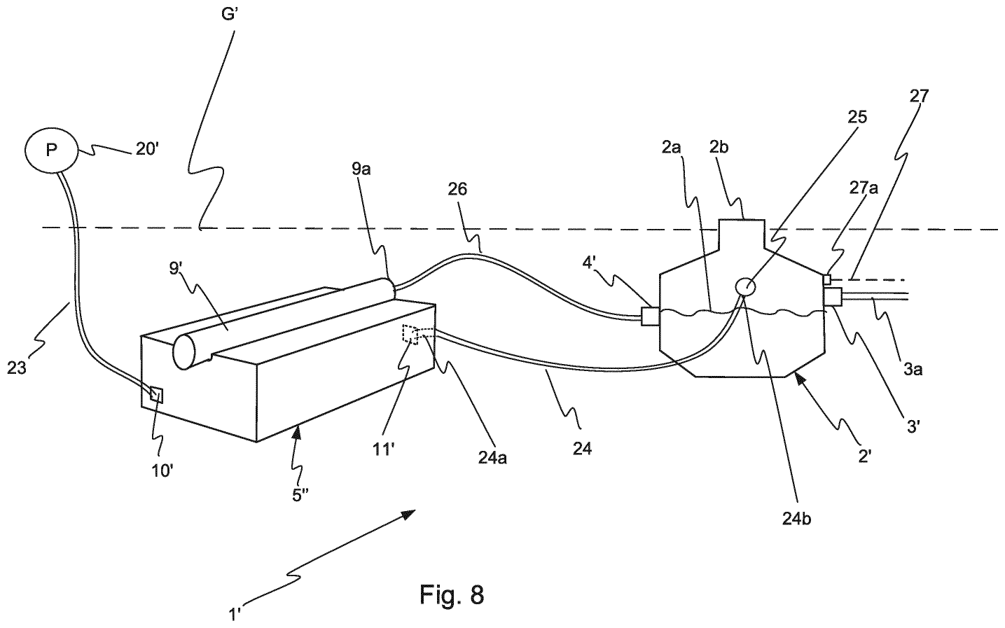

FIG. 8 shows a ventilated waste water purification system; and

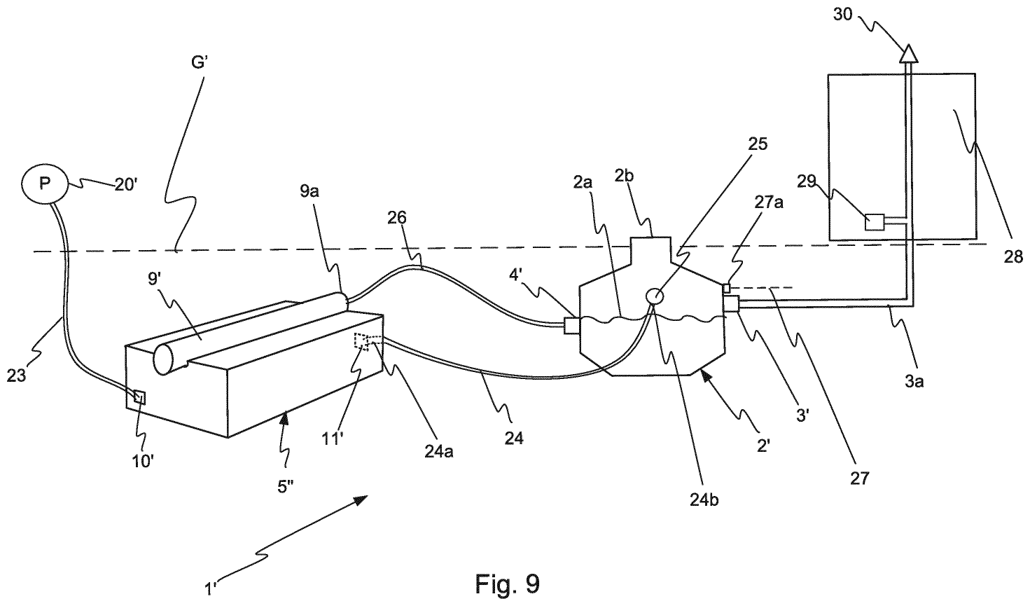

FIG. 9 shows a ventilated waste water purification system adjacent to a building.

### DETAILED DESCRIPTION

With reference to FIG. 1, a first version of a waste water treatment or purification system 1 is shown. The system 1 comprises a septic tank or sludge separator 2 with an inlet 3 for untreated waste water and an outlet 4 for water treated by the sludge separator 2 (particle sedimentation) and to be further treated. The purpose of the sludge separator 2 is to separate particle impurities from the water flowing there through, since the particle impurities are undesired in the following steps of the system 1. Furthermore, the system 1 further includes a waste water purification apparatus or module 5 in which the waste water is purified before it is discharged via a discharge pipe 6. In the shown embodiment, the waste water purification module 5 is arranged approximately 0.5 m below ground level G. The module 5 is covered by a protective rubber sheeting 21 on the side surfaces and on the top and bottom sides (see FIG. 3). On top of the module 5 a protective sheet of geo textile (not shown) is provided, and the module 5 is covered by soil mass (not shown).

In other embodiments, the module 5 may be arranged on other depths below the ground G, or on top of the ground G. The sludge separator 2 can—as an example—be of the kind disclosed in WO 2000/004972A1 developed by the present inventor. However, also other types of particle separating units can be installed before or upstream the water purification module 5.

Now, the waste water purification module 5 will be described in more detail with reference to FIGS. 2 and 3. The module 5 comprises a number of carrier elements, in this embodiment in the shape of plates 7, which will be explained in more detail later on. The carrier plates 7 are stacked vertically on top of each other, such that layers are formed. Between each layer of carrier plates 7 partitions 8 are sandwiched. In the disclosed embodiment, the partitions comprise sheets 8 of water permeable geo textile, for instance made from polyethylene. The geo textile sheets 8 are arranged in an overlapping manner amongst the different levels of carrier plates 7, such that they do not cover the entire surface of a carrier plate 7. Instead, they are arranged to cover a predetermined area between each pair of carrier plates 7. In the shown embodiment, between every other layer of carrier plates 7, the geo textile 8 is provided as a strip 8a in a mid area of the plate 7, not reaching all the way out to long sides 7a of the plate 7.

Moreover, between the remaining pairs of carrier plates 7, two strips 8b of geo textile are provided along each long side 7a of the plates 7, leaving a section in the middle without geo textile coverage. The strips 8a of geo textile provided in the middle area of the plates 7 are wider than the part of the neighbouring plate pair not being covered by geo textile, i.e. the area between the strips 8b located along the long sides 7a of the plates 7. Similarly, the strips 8b are wider compared to the area not covered by geo textile in a neighbouring plate pair. Thus, a kind of labyrinthine path is formed through the module 5 by means of the geo textile sheets 8a, 8b.

The purification module 5 further comprises an elongate distribution pipe 9 which is connected to the outlet 4 of the sludge separator 2 and which is disposed at the top of the stacked carrier plates 7 making up the module 5. The distribution pipe 9 has a number of perforations 18a, 18b along its length such that the water to be purified can reach the whole extension of the module 5. Furthermore, the module 5 comprises an air inlet channel 10 and an air outlet channel 11. Both channels 10, 11 extend horizontally through the module 5 and continue as vertical pipes 10a and 11a towards the ground surface G, as disclosed in FIG. 1.

As shown in FIG. 3, the bio module 5 is arranged in a bio bed assembly 12 with the discharge pipe 6 embedded in a layer of gravel 13. Between the gravel layer 13 and the module 5, a sand layer 14 is provided. The sand 14 and gravel 13 layers permit further purification of the water on its way towards the discharge pipe 6.

On top of the sand layer 14, a distribution plate 14a is provided. The distribution plate 14a distributes the waste water flowing out of the module 5 before it flows downwards into the sand layer 14 and further down into the gravel 13.

In FIG. 4, a portion of a carrier plate 7 is shown. The plate 7 comprises innumerable filaments 15 of e.g. thermoplastic polymer, which may be thermoset to obtain the plate-like shape. Preferably, the filaments 15 are irregularly twisted together which forms innumerable interspaces 16 between the filaments 15. Furthermore, it is preferred to use filaments 15 which are about 2-3 mm in diameter and which has a matte and rough, or rugged, surface. The plates 7 are preferably about 40 mm thick in this embodiment. In other embodiments, the diameter of the filaments 15 and the thickness of the plates 7 may vary. The rugged filaments 15 provide suitable surfaces for microbial growth. The twisting and meandering shape of the filaments 15 provide a very large attachment area for microbes within each carrier plate 7. As an example, a module 5 with a size of 110×55×25 cm has 82 m² of attachment surface.

In some embodiments, a plastic net 17 is inserted between a first carrier plate 7 and a neighbouring sheet 8 of geo textile, in order for the first carrier plate 7 to press the sheet 8 towards a neighbouring carrier plate 7 in an even way. One layer of such an assembly, comprising a carrier plate 7, a geo textile sheet 8 and a net 17, is shown in FIG. 5.

In the following, the water purification process of the system 1 will be described in connection with FIGS. 1 and 6. In use, the filaments 15 of the carrier plates 7 and the geo textile sheets 8 are covered by microbial growth, which decomposes BOD (Biochemical Oxygen Demand) and COD (Chemical Oxygen Demand).

Water or sewage to be treated or purified flows from a household, or other facility, to the sludge separator 2 via the inlet 3. In this septic tank or sludge separator 2, particle impurities are removed from the water. The decomposition of particle impurities requires a lot of oxygen. Therefore, it is advantageous to remove—at least to a great extent—these impurities already in the sludge separator 2. Thereafter, the water flows from the separator 2, via the outlet 4, into the purification module 5, via the distribution pipe 9. From the distribution pipe 9, the water trickles through the perforations 18a, 18b and into the sandwich structure of carrier plates 7. Since the carrier plates 7 comprise the interspaces 16, the water is able to pass through them. The carrier plates 7 are perfused by the waste water flowing through the module 5 in the way shown by arrows in FIG. 6.

Since the textile sheets 8 are covered by microbial growth, they are semi-permeable to water. Therefore, the water will partly pool on top of and flow along each sheet 8, and thus flow through the carrier plate 7 located above each sheet 8. This is marked by solid, black arrows in FIG. 6. However, some water will trickle through the sheets 8, which is marked by droplets 19. Thus, the water flows slowly, mainly back and forth through each layer of carrier plates 7, and partially through the sheets 8 of the module 5, allowing the bacteria to reduce the impurities (COD and BOD) carried therein. In an embodiment shown in FIG. 5 including the net 17 which presses the geo textile 8 towards the plate 7, the water pools more evenly on top of the geo textile 8, and therefore a more even bio skin production is promoted.

When the water reaches the bottom level of the module 5, it trickles out onto the distribution plate 14a and into the sand layer 14, and thereafter through the gravel layer 13, and finally through the discharge pipe 6.

Incoming air flows through the air inlet channel 10, effectively providing oxygen to the module 5. The oxygen transportation is shown as white arrows in FIG. 6. I.e. the oxygen is transported from the air inlet channel 10, as well as from the distribution pipe 9, towards the air outlet channel 11. The whole module 5 is thus effectively oxygenated.

Each level of carrier plates 7 can only receive a certain amount of water. Thus, the water which cannot be taken up by, and pass through the first level, will flush through the first level carrier plate 7 and down to the next level. In this process, old and dead microbial growth will be rinsed away from the carrier plate 7 of the first level and brought with the excess water to the next level of carrier plates 7. A chain reaction arises, in which excess water from each level brings the dead microbial growth towards the outlet of the module 5. Thus, the module 5 is self-cleaning and the risk of clogging due to material build up is reduced. This flushing process is most important for larger assemblies (not shown) with several modules 5 connected to each other, since they are more likely to become clogged. The flushing also occurs to a greater extent in such larger module 5 assemblies since they are exposed to a higher water flow.

In one embodiment (not shown), two or more modules can be connected to each other. In this case, guide tubes 22 are inserted, approximately 10 cm, into the air channels 10, 11 of a first module 5. An opposite end of the guide tube 22 protrudes approximately 10 cm outside the module 5. The protruding portion of the tube 22 is insertable into the air channels of a second, neighbouring module, and thus the air channels of both modules become aligned, and air can flow through the module assembly. A guide tube 22 is schematically depicted in the air outlet channel 11 in FIG. 2.

If needed, a compressor 20 or another air supplying device may be connected to the air inlet channel 10, as shown in FIG. 2. This may be suitable in case of high biological load on the module 5, or e.g. when several modules 5 are connected to each other, forming long air channels 10, 11.

A slightly modified waste water treatment module 5′ is illustrated in FIG. 7, in which the elongate distribution pipe 9 on top of the vertically stacked carrier plates 7 is disposed adjacent a lateral side of the module 5′. The partitions 8 are slightly different and are placed in another configuration which creates a modified flow of waste water within the module 5′ (as is illustrated by the arrows).

In the above, the waste water treatment bio module 5 has been described in a bio bed implementation, but it is also possible to use the module 5 in an infiltration implementation, or in an enhanced infiltration implementation. In the case of enhanced infiltration implementation, the gravel layer 13 and the discharge pipe 6 are excluded from the assembly. In the case of infiltration implementation, both the sand layer 14 and the gravel layer 13 as well as the discharge pipe 6 are excluded from the assembly. The distribution plate 14a is still used during infiltration.

It should be appreciated that modifications are feasible. For example, the partitions 8 are not limited to be made of geo textile, alternatively they may comprise open pore plastic foam or other permeable material. Also, the partitions 8 may have different thickness, and the partition 8 and the plastic net 17 may be produced as one unit. The number of carrier elements 7 and partitions 8—as well as the inter-related arrangement of these components—can vary depending on the specific purification demands or design requirements. Different flow patterns can be used in the module 5 as long as the aimed-at waste water treatment is achieved.

In FIG. 8 a second version of the waste water or sewage water treatment purification system is illustrated. This system 1′ comprises a septic tank or a sludge separator 2′, herein referred to as a waste water vessel 2′, with an inlet 3′ for untreated waste water and an outlet 4′ for water processed by the waste water vessel 2′. The inlet 3′ is arranged above a maximum waste water level 2a. The vessel 2′ also comprises an air inlet 25 placed above a maximum waste water level 2a in the vessel 2′. In addition, the vessel 2′ has an optional air outlet 27a also located above the maximum water level 2a.

For instance, the waste water vessel 2′ can be a container of the type described in WO 2000/004972A1 developed by the present inventor. However, also other types of particle separating units and waste water vessels can be used.

In the second version embodiment, the waste water treatment vessel 2′ is situated subsurface beneath a ground level G′. A top portion 2b of the waste water vessel 2′ protrudes above the ground level G′. The waste water vessel 2′ can in other embodiments be placed above ground level G′ (not shown).

Furthermore, the treatment system 1′ comprises a waste water purification apparatus or module 5″ in which the waste water is further treated and purified. Various modules 5″ can be used in the system 1′. In one example, the module 5″ provides surface area for the growth and culturing of a bio film. Microbes such as bacteria, suitable for degradation of contaminating particles present in waste water, inhabit the bio film.

Waste water flows through the bio film inside the bio module 5″, and microbes purify the water biologically. The direction of the flow is diverted either with the assistance of gravity or by the design of the module 5″ itself. Bio modules of this basic type are illustrated for instance in the Applicant's English-language brochure entitled “Sewage plants for single households up to 1000 people (and more)” from 2014.

In the second version embodiment, the waste water treatment module 5″ is arranged subsurface beneath the ground level G′. The module 5″ is covered with soil mass and possibly also by a protective sheet (not shown). For ventilation purposes, the module 5″ is equipped with an air inlet channel 10′ and an air outlet channel 11′. Furthermore, an elongated waste water distribution pipe 9′ is arranged on the top of the module 5″.

In addition, the system 1′ comprises an air supplying device 20′ which in the present embodiment is arranged above ground level G′. The air supplying device 20′, which herein is mainly referred to as a pump, may be a compressor, a membrane pump, air pump or the like. The air is supplied to the module 5″ through a first air conduit 23, herein also referred to as a first air pipe 23, connected between the pump 20′ and the air inlet channel 10′.

A second air conduit 24, herein also referred to as the second air pipe 24, is connected between the air outlet channel 11′ of the module 5″ and the vessel 2′. The second air pipe 24 has a first end portion 24a connected to the air outlet channel 11′, and a second end portion 24b connected to the air inlet 25 of the vessel 2′. In practice, the diameter of the second air pipe 24 is preferably about 50 mm, but other dimensions may be used. In certain situations, the second air pipe 24 may be provided with an external insulation material (not shown). The insulation material serves to keep the temperature within the second air pipe 24 at such level that condensation is prevented.

The air inlet 25 of the vessel 2′ is located above the maximum waste water level 2a. If the air inlet 25 is located beneath the water lever 2a, a higher air pressure would be needed to successfully press the air back into the vessel 2′. Since the air outlet channel 11′ is placed near the top surface of the module 5″ and since the air inlet 25 is arranged above the maximum water level 2a, sediment and filthy water are prevented from entering the second air pipe 24. A waste water pipe 26 is connected between the vessel 2′ and the distribution pipe 9′ of the module 5″.

In FIG. 9, the second version of the waste water purification system 1′ of FIG. 8 is installed adjacent to a house or other facility 28 which is equipped with a ventilation valve 30. A water inlet pipe 3a is connected to the ventilation valve 30 on the facility 28. Optionally, an air outlet 27a and an air pipe 27 of the vessel 2′ can also be installed to enhance ventilation. The ventilation valve 30 is not to be limited to be arranged on the roof top of the facility 28, but it could also for instance be placed in a wall of the facility 28. The water inlet pipe 3a is connected between the facility 28 and the water inlet 3′ of the vessel 2′. Air from the vessel 2′ exits the vessel 2 through the water inlet pipe 3a. A lavatory, sink or other sewage or waste water facility 29 within the building, herein referred to the waste water source 29, is connected to the water inlet pipe 3a.

The operation of the waste water treatment system 1′ will now be explained further. Waste water or sewage from the waste water source 29 of the facility 28 first arrives via the inlet pipe 3a and the inlet 3′ to the vessel 2′ which is advantageous due to its capability to sediment particle impurities from the waste water. The removal of particles already in the vessel 2′ enhances the efficiency of the purification in the module 5″ and a lower air supply is needed.

The waste water exits the vessel 2′ via the outlet 4′ and flows through the pipe 26 into a first end 9a of the elongated distribution pipe 9′ of the module 5″. From the distribution pipe 9′, water perfuses down into the module 5″ where it is biologically treated by microbes. Commonly, purified water flows out of the module 5″ through a discharge pipe and into layers of pebbles, gravel and sand (not shown).

Simultaneously, pressurized air is supplied to the module 5″ by means of the pump 20′. Air will flow through the first air pipe 23 and enter the module 5″ via the air inlet channel 10′. The air will travel upwards through the module 5″ towards the air outlet channel 11′ and assist the biological purification of the waste water by providing oxygen to the microbes. In addition, the air serves to maintain the module 5″ in a well functioning state, feeding the microbes such as bacteria with oxygen and preventing clogging of internal compartments of the module 5″.

Examples of air supplying devices are a membrane pump, an air pump, a compressor or the like. An approximate amount of air suitable for a facility adjacent to a family house may be 100 liters/minute. However, the distance between the vessel 2′ and the module 5″ will affect the suitable amount of air needed. The size of the module 5″ will also affect the need for a different amount of pressurized air.

The air is then led back into the waste water vessel 2′ through the second air pipe 24 via the air inlet 24a. Since the air inlet 24a is placed above the water level 2a, the procedure of pressing the air back into the vessel 2′ is facilitated.

Finally, air is ventilated out of the vessel 2′ through the water inlet pipe 3a and out through the ventilation valve 30. Optionally, air can also be ventilated through an air outlet 27a of the vessel 2′, into the air pipe 27. When supplying (pressurized) air to the vessel 2′, the pressure in the vessel 2′ increases and an overpressure is generated. Said overpressure decreases the risk of foul smell. Due to the overpressure in the vessel 2′, the air circulation is increased. This in turn decreases the risk of malodorous air standing still in the ventilation valve 30 and smell from the sewage or waste water is thus prevented. The inlet 3′ is arranged above the maximum waste water level 2a of the vessel 2′ in order to ensure that the use of the water inlet pipe 3a as an exit for air to escape the vessel 2′ becomes effective.

As stated above, the distance between the module 5″ and the vessel 2′ will affect the need of a higher or lower air pressure. When the distance between the module 5″ and the vessel 2′ increases, higher air pressure will be required in order to press the air into the vessel 2′ in a satisfactory manner. The system 1′ is well functioning when the module 5″ and the vessel 2′ are spaced about 20 meters, preferably spaced 8-10 meters, and most preferred 3 meters apart from each other.

The system 1′ according to the second version in FIGS. 8-9 is a ventilated system for efficient waste water treatment. The ventilation enhances the biological cleansing of the waste water, makes the cleansing process more efficient and reduces the risk of clogging caused by dead bio film. The system 1′ according to the second version also reuses the air supplied to the module 5″ by diverting it further to the vessel 2′. This creates a system with low risk of foul odor from the vessel 2′ and ventilation valves 30 of adjacent facilities 28.

### Certain Aspects and Embodiments of the Second Version

In one aspect, there is provided a ventilated system for waste water treatment 1′ comprising a waste water vessel 2′, a waste water treatment module 5″, an air supplying device 20′ connected to an air inlet channel 10′ of the module, and an air conduit 24 configured to lead air from an air outlet channel 11′ of said module 5″ to an air inlet 25 of said vessel 2′.

In one embodiment, the waste water vessel 2′ is arranged at least partly below a ground level G′.

The waste water vessel 2′ may be a septic tank or a sludge separator.

The module 5″ is preferably configured to receive air through said air inlet channel 10′ and to lead said air out of the module 5″ through said air outlet channel 11′.

In one embodiment, a first end portion 24a of said air conduit 24 is connected to the air outlet channel 11′ of the module, wherein a second end portion 24b of said air conduit 24 is connected to said waste water vessel 2′.

Preferably, the air inlet 25 of the vessel 2′ is located above a water level 2a of the vessel 2′.

In one embodiment, the vessel 2′ further comprises an air outlet 27a configured to lead air to a ventilation valve 30.

The module 5″ is preferably arranged in a bio bed.

In one embodiment, the air supplying device 20′ is one of a compressor, a membrane pump or an air pump.

In a second aspect, there is provided a method for ventilating a waste water treatment module 5″ of said system 1′. The method comprises the steps of supplying air to the module 5″, and leading the air through said air conduit 24, such that said air is diverted from said module 5″ into said waste water vessel 2′.

In one embodiment, the air is supplied to generate an overpressure in the vessel 2′, such that ventilation of said vessel 2′ is eased.

In a third aspect there is provided a kit for providing ventilation to a waste water treatment system 1′ including a waste water treatment module 5″ and a waste water vessel 2′. The kit comprises an air supplying device 20′ and an air conduit 24 configured to feed air from the waste water treatment module 5″ to the waste water vessel 2′.

In a fourth aspect the use of an air conduit in a waste water treatment system 1′ is provided, for connecting a waste water treatment module 5″ to a waste water vessel 2′ included in said system 1′, such that air is reused.

Finally, it should be mentioned that the inventive concept is not limited to the embodiments described herein, and many modifications are feasible within the scope of the appended claims. For instance, several modules, vessels and pumps may be combined into a larger water treatment installation, where each module is connected to one vessel or several modules are connected to the same vessel or several vessels are connected to a lower number of modules. The pump may be connected to one or more modules. Furthermore, the specific design of the conduits between the arrangements included in the system may vary.

1. A module for treatment of waste water, comprising:
a number of carrier elements arranged in a sandwich structure, said carrier elements being configured to be perfused by a flow of waste water; and
a number of partitions arranged between said carrier elements, said partitions being configured to direct the flow of waste water through the module.

2. The module as claimed in claim 1, wherein the carrier elements and the partitions are configured to be covered by microbial growth.

3. The module as claimed in claim 1, wherein the partitions are arranged to direct the flow of water in a meandering manner through the module.

4. The module as claimed in claim 1, wherein each carrier element comprises a plate of irregularly twisted filaments.

5. The module as claimed in claim 1, wherein the partitions comprise sheets of geo textile.

6. The module as claimed in claim 1, wherein the partitions are semi-permeable to water.

7. The module as claimed in claim 1, further comprising a distribution pipe for delivering the waste water to the module.

8. The module as claimed in claim 1, further comprising an air inlet channel and an air outlet channel for supplying oxygen to microbes.

9. A method for treatment of waste water, comprising the steps of:
a) providing a module according to claim 1;
b) supplying waste water to the module, wherein the water travels through the module.

10. The method as claimed in claim 9, further comprising the step of providing a suitable environment for microbial growth in the module, preferably by supplying oxygen and moist to the module.

11. The method as claimed in claim 10, wherein the water partly passes through the partitions and partly travels through the carrier elements of the module such that the water passes the microbes purifying the water.

12. The method as claimed in claim 9, further comprising the step of supplying air to the module by means of an air supplying device.

13. The method according to claim 12, further comprising the step of leading the air supplied to the module by the air supplying device through an air conduit, such that said air is diverted from said module into a waste water vessel.

14. The method according to claim 13, wherein air is supplied to generate an overpressure in the vessel, such that ventilation of said vessel is eased.

15. A carrier element to be included in a waste water treatment module as claimed in claim 1, said carrier element comprising irregularly twisted filaments.

16. (canceled)

17. A waste water treatment system, comprising a waste water vessel and at least one module as claimed in claim 1.

18. A ventilated system for waste water treatment, comprising a waste water vessel, a waste water treatment module as claimed in claim 1, an air supplying device connected to an air inlet channel of the module, and an air conduit configured to lead air from an air outlet channel of said module to an air inlet of said vessel.

19. The system according to claim 18, wherein the waste water vessel is arranged at least partly below a ground level.

20. The system according to claim 18, wherein the waste water vessel is a septic tank or a sludge separator.

21. The system according to claim 18, wherein the module is configured to receive air through said air inlet channel and to lead said air out of the module through said air outlet channel.

22. The system according to claim 18, wherein a first end portion of said air conduit is connected to the air outlet channel of the module, and wherein a second end portion of said air conduit is connected to said waste water vessel.

23. The system according to claim 18, wherein said air inlet of the vessel is located above a water level of the vessel.

24. The system according to claim 18, wherein the vessel further comprises an air outlet configured to lead air to a ventilation valve.

25. The system according to claim 18, wherein the module is arranged in a bio bed.

26. The system according to claim 18, wherein the air supplying device is one of a compressor, a membrane pump or an air pump.

27. A kit for providing ventilation to a waste water treatment system including a waste water treatment module and a waste water vessel,
said waste water treatment module, comprising a number of carrier elements arranged in a sandwich structure, said carrier elements being configured to be perfused by a flow of waste water; and a number of partitions arranged between said carrier elements, said partitions being configured to direct the flow of waste water through the module; and
said kit comprising an air supplying device and an air conduit configured to feed air from the waste water treatment module to the waste water vessel.

28. (canceled)
